(19) United States
(12) Patent Application Publication
(10) Pub. No.: US 2026/0332475 A1
(43) Pub. Date: Oct. 22, 2026

(54) DATA COLLECTION AND DISTRIBUTION IN A WIRELESS COMMUNICATION NETWORK

(71) Applicant: Lenovo (Singapore) Pte. Limited, Singapore (SG)

(72) Inventors: Emmanouil Pateromichelakis, Viersen (DE); Konstantinos Samdanis, Munich (DE)

(73) Assignee: Lenovo (Singapore) Pte. Limited, Singapore (SG)

(21) Appl. No.: 19/107,758

(22) PCT Filed: Oct. 11, 2022
(86) PCT No.: PCT/EP2022/078321

§ 371 Date: Feb. 28, 2025

(30) Foreign Application Priority Data
Sep. 1, 2022 (GR) 20220100717

(51) Int. Cl. H04L 41/0816; H04L 41/0895; H04L 43/08; H04L 43/20

(52) U.S. Cl. CPC H04L 41/0816; H04L 41/0895; H04L 43/08; H04L 43/20

(57) ABSTRACT

There is provided a method in a data collection and distribution application entity. The method comprises receiving a request from a service consumer, the request related to a radio related performance analytics event, and determining at least one data source for data related to the radio related performance analytics event. The method further comprises configuring at least one parameter related to the data collection from at least one determined data source, based on the radio related performance analytics event; and sending the at least one configured parameter to the at least one data source based on the radio related performance analytics event. The method further comprises receiving data from the at least one data source data source, processing received data to produce processed data, and sending the processed data to the service consumer.

### FIELD

The subject matter disclosed herein relates generally to the field of implementing data collection and distribution in a wireless communication network. This document defines a method in a data collection and distribution application entity and a data collection and distribution application entity.

### BACKGROUND

O-RAN [https://www.o-ran.org/] is an alliance that investigates the virtualization of the access domain. O-RAN considers the virtualization of control functionalities (such as Radio Resource Control (RRC) and/or Radio Resource Management (RRM)) to a newly defined Radio Access Network (RAN) Intelligent Controller (RIC), which may be co-located with the gNB or can be deployed to facilitate control functionalities for a cluster of gNBs. In this context, given the deployment requirements (i.e., real-time, non-real time, near real-time) as well as the slice isolation policies, the RRM/RRC functionalities can be either flexibly located either at the Central Unit (CU) and/or a Distributed Unit (DU) or to dedicated RIC controllers, e.g., Near-RT RIC and Non-RT RIC.

O-RAN has defined different xApps which can be, for example, abstracted Self Organized Networks (SON) or Radio Resource Management (RRM) capabilities at the application side (third party, operator, vendor deployed). Such xApps may be used to realize the following capabilities: traffic steering, QoS/QoE optimization, RAN slice assurance, and RAN sharing. Further, xApps may be used for RAN performance analytics and Artificial Intelligence (AI) and/or Machine Learning (ML) support for facilitating RRM/SON optimizations.

### SUMMARY

A problem with existing implementations concerns how to coordinate the data collection from heterogeneous sources for RAN analytics derivation, especially for open/virtualized RAN deployments.

Disclosed herein are procedures for data collection and distribution in a wireless communication network. Said procedures may be implemented by a method in a data collection and distribution application entity and a data collection and distribution application entity.

Accordingly, there is provided a method in a data collection and distribution application entity. The method comprises receiving a request from a service consumer, the request related to a radio related performance analytics event, and determining at least one data source for data related to the radio related performance analytics event. The method further comprises configuring at least one parameter related to the data collection from at least one determined data source, based on the radio related performance analytics event; and sending the at least one configured parameter to the at least one data source based on the radio related performance analytics event. The method further comprises receiving data from the at least one data source, processing the received data to produce processed data, and sending the processed data to the service consumer.

There is further provided a data collection and distribution application entity comprising a transceiver and a processor. The transceiver is arranged to receive a request from a service consumer, the request related to a radio related performance analytics event. The processor is arranged to determine at least one data source for data related to the radio related performance analytics event. The processor is further arranged to configure at least one parameter related to the data collection from at least one determined data source, based on the radio related performance analytics event. The transceiver is further arranged to send the at least one configured parameter to the at least one data source based on the radio resource performance analytics event. The transceiver is further arranged to receive data from the at least one data source. The processor is further arranged to process the received data to produce processed data. The transceiver is further arranged to send the processed data to the service consumer.

Such a method and apparatus tends to provide a mechanism for coordinating data collection from heterogeneous sources for RAN analytics derivation. Doing this is especially problematic for open and/or virtualized RAN deployments. The methods and apparatus presented herein describe how heterogeneous radio related data can be collected and prepared, so as to allow RAN analytics to be derived for different applications with distinct granularity standards. The methods and apparatus presented herein describe how to enable the exposure of RAN analytics from different applications with distinct abstraction and authorization requirements governed by SLA with a mobile network operator. The RAN analytics may be UE or cell or slice associated analytics.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for data collection and distribution in a wireless communication network will now be described, by way of example only, with reference to the accompanying drawings, in which:

FIG. 1 depicts an embodiment of a wireless communication system for data collection and distribution in a wireless communication network;

FIG. 2 depicts a user equipment apparatus that may be used for implementing the methods described herein;

FIG. 3 depicts further details of the network node that may be used for implementing the methods described herein;

FIG. 4 illustrates a method in a data collection and distribution application entity;

FIG. 5 illustrates a high-level O-RAN architecture;

FIG. 6 illustrates a possible way of a system integrationg an O-RAN and a 5G system.

FIG. 7 illustrates a system comprising 5G core entities as defined in In 3GPP TS 23.288v17.5.0;

FIG. 8 illustrates a high-level architecture including a Data Collection Application Function (DCAF);

FIG. 9 illustrates an example of an ORAN RIC architecture;

FIG. 10 illustrates a method performed by a data collection and distribution xApp when operating in a system such as a wireless communication network;

FIG. 11 illustrates a further method performed by the data collection and distribution xApp operating in a system such as a wireless communication network;

FIG. 12 illustrates an example of a method of collecting heterogeneous data for deriving RAN Performance Analytics;

FIG. 13 illustrates a process for exposing RAN analytics using a data collection and distribution xApp; and

FIG. 14 illustrates an architecture, wherein a data collection and distribution application function as enhancement of DCAF.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of Band C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

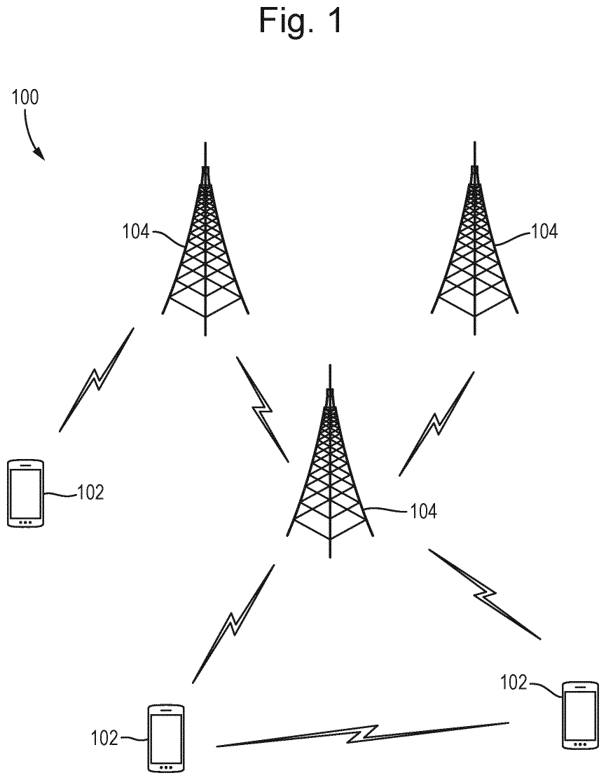

FIG. 1 depicts an embodiment of a wireless communication system 100 for data collection and distribution in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200, or a UE 810, 1005, 1410. The base unit 104 may comprise a network node 300, gNB 640, a Data Collection AF 820, a Near-RT RIC 510, 1015, 1115, a DCDSP 1220, a DCD Function 1320, or a DCDCAF 1420.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

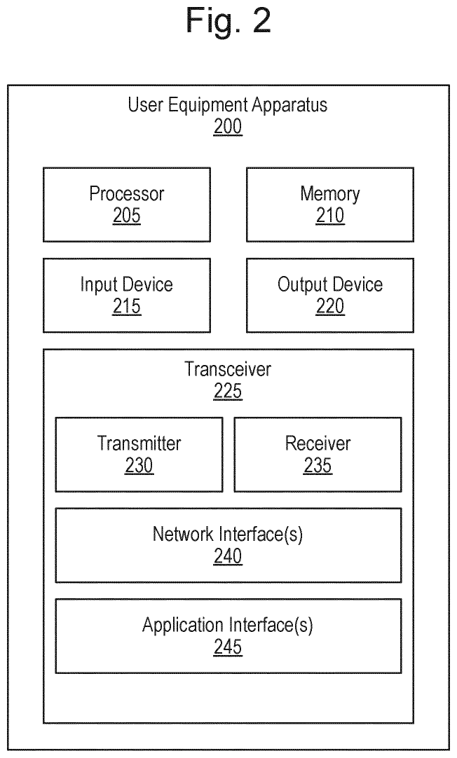

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102 or a UE 810, 1005, 1410. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

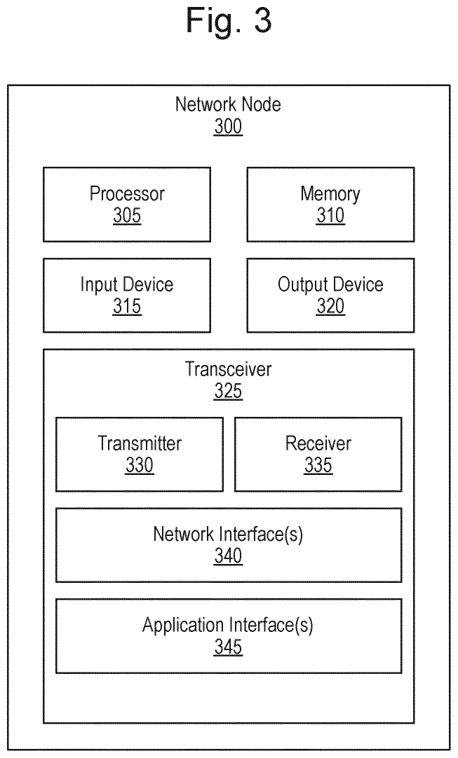

FIG. 3 depicts further details of the network node 300 that may be used for implementing the methods described herein. The network node 300 may comprise a base unit 104, a gNB 640, a Data Collection AF 820, a Near-RT RIC 510, 1015, 1115, a DCDSP 1220, a DCD Function 1320, or a DCDCAF 1420. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

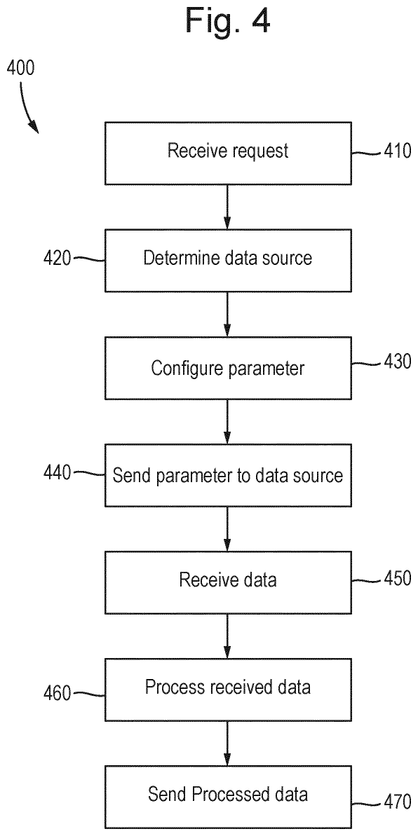

FIG. 4 illustrates a method 400 in a data collection and distribution application entity. The method 400 comprises receiving 410 a request from a service consumer, the request related to a radio related performance analytics event, and determining 420 at least one data source for data related to the radio related performance analytics event. The method 400 further comprises configuring 430 at least one parameter related to the data collection from at least one determined data source, based on the radio related performance analytics event; and sending 440 the at least one configured parameter to the at least one data source based on the radio related performance analytics event. The method 400 further comprises receiving 450 data from the at least one data source, processing 460 the received data to produce processed data, and sending 470 the processed data to the service consumer.

Such a method tends to provide a mechanism for coordinating data collection from heterogeneous sources for RAN analytics derivation. Doing this is especially problematic for open and/or virtualized RAN deployments. The methods and apparatus presented herein describe how heterogeneous radio related data can be collected and prepared, so as to allow RAN analytics to be derived for different applications with distinct granularity standards. The methods and apparatus presented herein describe how to enable the exposure of RAN analytics from different applications with distinct abstraction and authorization requirements governed by SLA with a mobile network operator. The RAN analytics may be UE or cell or slice associated analytics.

The data collection and distribution application entity may be external to a wireless communication network. The data collection and distribution application entity may reside in a first domain. The at least one data source may belong to a second domain different to the first domain. The data collection and distribution application entity may be an entity in a virtualized RAN environment. The virtualized RAN environment may comprise an O-RAN. The data collection and distribution application entity may be a RIC function. The data collection and distribution application entity may be part of a near-real-time RIC. The data collection and distribution application entity may comprise: an xApp, a DCAF, an application function, a network function, an application enablement entity, a RAN entity, an OAM entity, a platform entity, an external application entity or a combination thereof.

The radio related performance analytics event may relate to a radio access network (RAN). The radio related performance analytics event may relate to an O-RAN. The radio related performance analytics event may be at least one of: about radio parameters; RAN associated; cell associated, UE associated; and slice associated.

The radio related performance analytics event may relate to a service level agreement with the service consumer. The radio related performance analytics event may relate to a service level agreement with the service provider. The service provider may be the operator of the data collection and distribution application entity

The at least one data source may be heterogeneous. The received data may: comprise data of different types; comprise data of different granularities; and/or relate to different domains.

The method may further comprise regulating the processed data before sending the processed data to the service consumer. Regulating the processed data may comprise ensuring that sending conditions are satisfied. The sending conditions may be predetermined, externally configured, and/or set by a service level agreement.

The data collection and distribution application entity may be an xApp. The xApp may be in a first cloud different to a second cloud, wherein the near-real-time RIC is part of the second cloud. The xApp may be logically part of the near-real-time RIC but physically somewhere else. Collecting data from at least one determined data source may comprise collecting data from a plurality of sources.

The request from the service consumer may be a data and/or analytics event subscription request. The service consumer may be a RAN analytics consumer. The analytics may be RAN analytics. The service consumer can be also a RAN data consumer.

The radio related performance analytics event may relate to a service level agreement between the service consumer and the data collection and distribution application entity provider. The data collection and distribution application entity provider can be one of: the MNO, O-RAN operator, a telco vendor, a vertical application layer entity, a RAN entity (CU or DU or RU) vendor, a telco platform provider, an edge provider, an application service provider. The at least one parameter related to the data collection from at least one determined data source, may be configured based on the service level agreement with the service consumer. The configured parameter may comprise a subscription request, or a subscription to the at least one data source.

The received data comprise at least one of: Machine Learning (ML) training/inference data from ML support RIC, RAN parameters from R-NIB, UE parameters from UE-NIB, E2 measurements from E2 nodes, NWDAF/MDAS data from MNO, other xApp data from SON outputs, MEC RNIS or VIS data, and SMO non-RT data. E2measurements from E2 nodes may be UE associated or RAN associated or slice associated.

Processing received data may comprise abstraction. The abstraction may serve the purpose of hiding sensitive data. Sensitive data may comprise, for example, user identities and/or network topology.

Processing received data may comprise combining data collected from a plurality of data sources. The processing may be provided per radio related performance analytics event, or per analytics ID, or for a given analytics service area, or for a given service profile. The analytics service area may comprise, for example, a cell area, or a slice coverage area. Combining data from a plurality of sources may comprise targeting the same resources from multiple data sources. For example, the same resources may be RAN and UE. The multiple data sources may comprise near-RT data related to RAN performance, near-RT data related to UE performance, resource availability data, QoS/QoE data, location/positioning data. The processed data may comprise data analytics.

The method may further comprise storing a data source list with the request for analytics related to a radio related performance analytics event. The data source list may contain data source IDs per use case.

The method may further comprise sending analytics to the service consumer when a sending condition is satisfied.

The method may further comprise registering the data collection and distribution application entity with each of a plurality of data sources.

Determining data sources for data related to the radio related performance analytics event may comprise selecting data sources from the plurality of data sources with which the collection and distribution function is registered.

There is further provided a data collection and distribution application entity comprising a transceiver and a processor. The transceiver is arranged to receive a request from a service consumer, the request related to a radio related performance analytics event. The processor is arranged to determine at least one data source for data related to the radio related performance analytics event. The processor is further arranged to configure at least one parameter related to the data collection from at least one determined data source, based on the radio related performance analytics event. The transceiver is further arranged to send the at least one configured parameter to the at least one data source based on the radio related performance analytics event. The transceiver is further arranged to receive data from the at least one data source. The processor is further arranged to process the received data to produce processed data. The transceiver is further arranged to send the processed data to the service consumer.

Such an apparatus tends to provide a mechanism for coordinating data collection from heterogeneous sources for RAN analytics derivation. Doing this is especially problematic for open and/or virtualized RAN deployments. The methods and apparatus presented herein describe how heterogeneous radio related data can be collected and prepared, so as to allow RAN analytics to be derived for different applications with distinct granularity standards. The methods and apparatus presented herein describe how to enable the exposure of RAN analytics from different applications with distinct abstraction and authorization requirements governed by SLA with a mobile network operator. The RAN analytics may be UE or cell or slice associated analytics.

The data collection and distribution application entity may be an xApp. The xApp may be in a first cloud different to a second cloud, wherein the near-real-time RIC is part of the second cloud. The xApp may be logically part of the near-real-time RIC but physically somewhere else. Collecting data from at least one determined data source may comprise collecting data from a plurality of sources.

The request from the service consumer may be a data and/or analytics event subscription request. The service consumer may be a RAN analytics consumer. The analytics may be RAN analytics. The service consumer can be also a RAN data consumer.

The radio related performance analytics event may relate to a service level agreement between the service consumer and the data collection and distribution application entity provider. The data collection and distribution application entity provider can be one of: the MNO, O-RAN operator, a telco vendor, a telco platform provider, an edge provider, an application service provider. The at least one parameter related to the data collection from at least one determined data source, may be configured based on the service level agreement with the service consumer. The configured parameter may comprise a subscription request, or a subscription to the at least one data source.

The received data may comprise at least one of: Machine Learning training data and/or Machine Learning inference data, Radio Access Network parameters from Radio Access Network—Network Information Base, User Equipment parameters from User Equipment—Network Information Base, E2 data from E2 nodes, data analytics from one or more 3GPP sources, data from one or more xApps related to Self Organized Networks and/or Radio Resource Management outputs, radio related data from Mobile Edge Computing Radio Network Information Service and/or V2X Information Service, and non-Real-Time data from Service Management and Orchestration and/or Operations Administration and Management. Data from a data source may comprise measurements taken by the data source. The received data may comprise Machine Learning training data and/or Machine Learning inference data from either non-RT RIC or near-RT RIC.

Examples of 3GPP sources of received data are: Network Data Analytics Function (NWDAF), Management Data Analytics Service (MDAS), and Application Data Analytics Service (ADAES). Application Data Analytics Service (ADAES) is defined in 3GPP TR 23.700-36 v0.4.0. ADAES is an enablement service (which can be part of SEAL) and discusses potential application data analytics services (such as statistics and/or predictions) to optimize the application service operation by notifying the application specific layer, and potentially 5GS, for expected/predicted application service parameters changes considering both on-network and off-network deployments (e.g., related to application QoS parameters).

The processor processing received data may comprise the processor performing an abstraction operation. The abstraction operation may serve the purpose of hiding sensitive data. Sensitive data may comprise, for example, user identities and/or network topology.

The processor processing received data may comprise combining data collected from a plurality of data sources. Combining data from a plurality of sources may comprise targeting the same resources from multiple data sources. For example, the same resources may be RAN and UE. The multiple data sources may comprise near-RT data related to RAN performance, near-RT data related to UE performance, resource availability data, QoS/QoE data, location/positioning data. The processed data may comprise data analytics.

The data collection and distribution application entity may further comprise a storage component arranged to store a data source list with the request for analytics related to a radio related performance analytics event. The data source list may contain data source IDs per use case.

The transceiver may be further arranged to send analytics to the service consumer when a sending condition is satisfied.

The data collection and distribution application entity may be arranged to register itself with each of a plurality of data sources.

Determining data sources for data related to the radio related performance analytics event may comprise the processor selecting data sources from the plurality of data sources with which the collection and distribution function is registered.

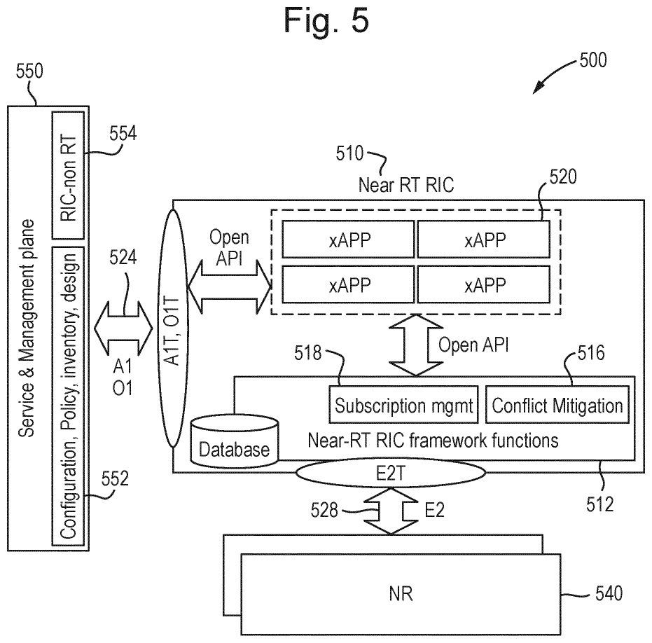

FIG. 5 illustrates a high-level O-RAN architecture 500. The architecture 500 comprises a Near real-time RIC 510, an NR node 540, and a service and management plane 550. The near real-time RIC 510 comprises at least one xAPP 520 and Near-real-time RIC framework functions. The near-real-time RIC framework functions include subscription management 518 and conflict mitigation 516. The service and management plane 550 comprises a configuration, policy, inventory and design function 552, and a non-real-time RIC 554. The near-real-time RIC 510 communicates with the NR node 540 using an E2 interface 528. The near-real-time RIC 510 communicates with the service and management plane 550 using an A1 and an O1 interface 524.

The non-RT RIC 554 is a logical function that enables non-real-time control and optimization of RAN elements and resources, AI/ML workflow including model training and updates, and policy-based guidance of applications/features in Near-RT RIC 510.

The near-RT RIC 510 and framework functions 512 are a logical function that enables near-real-time control and optimization of RAN elements and resources via fine-grained (e.g., UE basis, Cell basis) data collection and actions over E2 interface 528. Near-RT RIC 510 comprises near-RT RIC basic/framework functions, which can be for example subscription management 518, conflict mitigation 516, E2 termination (E2T) etc.

The Conflict Mitigation function 516 is a function which is part of Near RT RIC 510 and is used to avoid conflicting control messages from different xAPPs 520. Based on the output of conflict mitigation, the E2T generates only one reasonable control message on E2 interface 528.

The Subscription Management function 518 is the functionality where xAPPs 520 subscribe to for controlling E2 nodes such as NR node 540. This function merges identical subscriptions from different xApps 520. Based on the output of subscription management, the E2 termination (E2T) generates only one message to E2 nodes 540.

An xApp 520 is an application designed to run on the Near-RT RIC 510. Such an application is likely to consist of one or more microservices and at the point of on-boarding will identify which data it needs to consume and which type of data it will provide as output. The application is independent of the Near-RT RIC 510 and may be provided by any third party. The E2 interface 528 enables a direct association between the xApp 520 and the RAN functionality.

The A1 Interface 524 between non-RT RIC 554 and Near-RT RIC 510 enables policy-driven guidance of Near-RT RIC applications/functions, and support AI/ML workflow.

The E2 Interface 528 connects the Near-RT RIC 510 and NR node 540.

An rApp is an application designed to run on the Non-RT RIC 554. Such an application includes one or more microservices and at the point of on-boarding will identify which data it needs to consume and which type of data it will provide as output. The application is independent of the Non-RT RIC 554 and may be provided by any third party.

An E2 Node is a logical node terminating E2 interface (e.g., NR nodes 540 like O-CU-CP, O-CU-UP, O-DU, or virtualized eNodeB).

An Open API or RIC API provides the interface between the Near-RT RIC framework functions 512 and xAPPs 520.

With respect to the interworking with the 5G system, O-RAN may be deployed in various ways. Some possible scenarios include:
Overlapping Coverage vs non-overlapping. In particular, the O-RAN can be deployed for the same or partial overlapping coverage as 5G access, or in orthogonal manner (e.g., ORAN cells deployed in coverage gaps, e.g., stadiums).
Co-channel vs orthogonal channel. ORAN can either operate in similar spectrum as 5G access or use orthogonal spectrum.
UEs with dual connectivity/single connectivity: ORAN is used as a secondary access network in addition to the master/anchor 5G access. In that case, UEs supporting dual radio, are able to connect simultaneously in both networks (belonging to the same or different operators).
ORAN operator can be the 5GS operator or can be a different operator (e.g., service provider, event provider like for stadium event).

Based on the different deployment considerations for ORAN with respect to 5GS, there may be different possible synergies among different radio access technologies (RATs). These might be RAN based or UE based.

Examples of RAN-based synergies are: O-RAN operator and MNO interact for dynamic resource management (e.g., avoiding conflicts) when deployed with overlapping coverage, co-channel deployment, e.g., ICIC/FFR; and O-RAN and MNO interact for exchanging network related analytics in overlapping coverage (can be provided as a service).

Examples of UE-based synergies are: O-RAN and MNO interact when a UE handover/when a UE is expected to handover to a different network (due to high load, app preference, mobility); O-RAN and mobile network operator (MNO) interact for non-roaming multi-operator scenarios (for indirect service-to-device (D2D) and/or vehicle-to-vehicle (V2V), the end-to-end (e2e) service can be multi-operator); and O-RAN and MNO interact for exchanging UE related analytics in overlapping coverage or when a handover is expected (can be provided as a service).

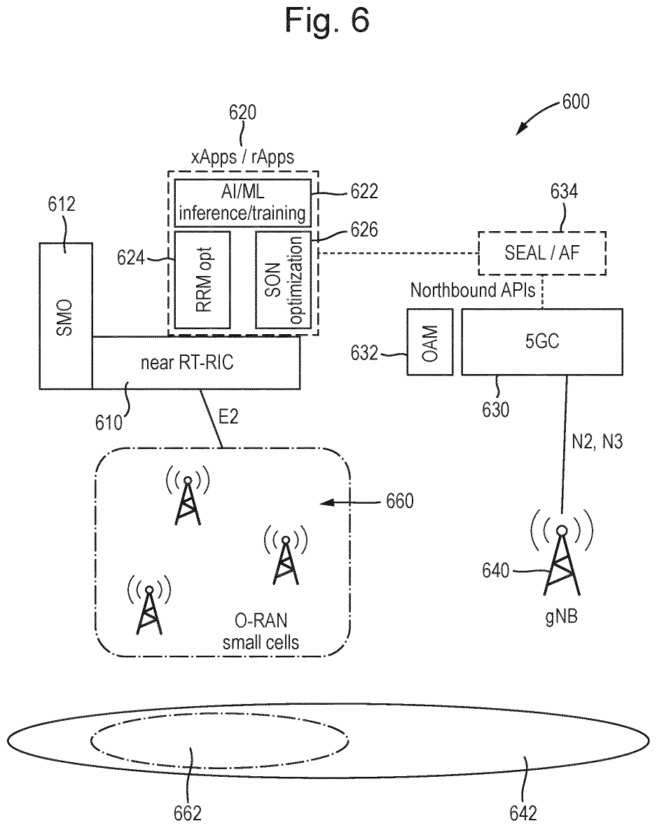

FIG. 6 illustrates a possible way of a system 600 integrating an O-RAN and a 5G system. The system 600 comprises a RIC 610, and SMO 612, xApps 620, a SEAL 634, a 5G core 630, an Operations, Administration and Maintenance (OAM) 632, a gNB 640, and a plurality of O-RAN small cells 660. The coverage area 662 of the O-RAN small cells 660 falls wholly within the coverage area 642 of the gNB 640. xAPPs 620 comprise, for example, an AI/ML inference and/or training function 622, an RRM opt 624, and/or an SON optimization 626. The integration is accomplished in application layer using xApps/rApps 620 as Application functions, or on the other hand 5GC 630 defined Application functions may interact with ORAN via xApps 620. SEAL/AF/NEF 634 can play role at the integration as middle layer/exposure gateway.

As mentioned above, xApps and RIC functions can be deployed as external apps or AFs with respect to 5GS or alternatively, the MNO provided AF/NF can consume RIC services via intermediate xApps or directly. This can be performed for Consuming 5GC services and Producing services to be consumed by 5GC.

Consuming 5GC services to help getting information per session (when UE is served by both networks, or a UE is expected to handover) or per cell/tracking area, such as: Location services; QoS monitoring; QoS/traffic routing influence; and Network Analytics from NWDAF.

Producing services to be consumed by 5GC may comprise: RAN analytics from RIC; Location services (complement LMF); Providing SON/RRM optimization outputs (based on xApp optimizations in O-RAN area) to 5GS; and Providing AI/ML model inference to allow for real time analytics to complement analytics input needed at NWDAF, e.g., RAN analytics for Analytics ID=“Network Performance”.

RAN analytics from O-RAN side assumes that data can be provided by E2 nodes. However, such data can be provided by different sources, which may include the following: RIC Databases; SMO; 5GS (MDAS, NWDAF); UEs (via application layer); E2 nodes; MEC services; and RRM/SON xApps.

There is provided herein a new capability at RIC (as new xApp) which is introduced to support the data collection from heterogeneous data sources. More specifically, there is provided a solution to the problem of how heterogeneous radio related data can be collected and prepared to allow RAN analytics (UE or cell or slice associated analytics) to be derived for different applications with distinct granularity needs The solution described herein additionally addresses the problem of how to enable the exposure of RAN analytics considering different applications with distinct abstraction and authorization requirements governed by SLA with the network operator.

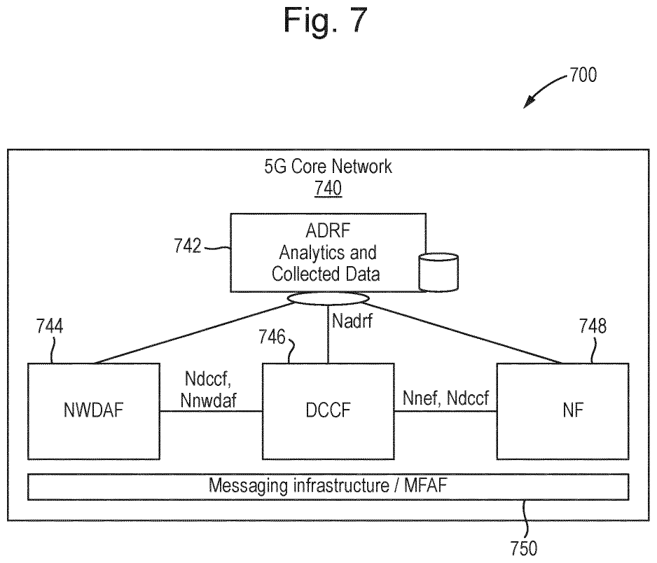

FIG. 7 illustrates a system 700 comprising 5G core entities as defined in 3GPP TS 23.288v17.5.0. 5G core 740 comprises an Analytical Data Repository Function (ADRF) 742, Network Data Analytics Function (NWDAF) 744, Data Collection Coordination Function (DCCF) 746 a Network Function (NF) 748, and messaging infrastructure in the form of a Messaging Framework Adaptor Function (MFAF) 750. Analytics are provided in the control plane, i.e., 5GC, with the advent of the NWDAF 744 as well as in the management plane with the introduction of Management Data Analytics Function (MDAF, not shown).

In NWDAF 744 the main analytics services which collect data from the user-plane sessions (from UPF and/or AF) are the following:
Observed Service Experience related network data analytics include: Service experience for a UE or a group UEs or any UE in an Application or a set of Applications over a specific UP path (UPF, DNAI and EC server). The inputs are from AF, NFs and OAM. From UPF the inputs are: QoS flow bit rate, QoS flow packet delay, #of packet Tx/re-Tx. From AF the inputs are: QoE metrics, service experience, app location. From OAM: QoS flow related measurements and e2e KPIs as per 3GPP TS 28.552 v17.7.1 and 3GPP TS 28.554v17.7.0.
WLAN performance analytics (UE UL/DL data rate and traffic volume)
UE mobility, communications, and abnormal behavior analytics (NWDAF 744 collects UE mobility, UL/DL data rate and traffic volume from UPF and N4 session level data).
User data congestion analytics. NWDAF 744 gets from UPF or AF: UL/DL throughput and peak UL/DL throughput. OAM gets from UPF and SMF QoS and session performance measurements as per 3GPP TS 28.552 v17.7.1 and 3GPP TS 28.554v17.7.0.
Redundant Transmission Experience related analytics (UL/DL packet delay from UE to UPF).
DN Performance Analytics (performance data from AF like Average Packet Delay, Average Loss Rate and Throughput).

Data Collection Coordination and Delivery coordinates the collection and distribution of data requested by NF consumers. Data Collection Coordination is supported by a DCCF 746. Data Consumers send requests for data to the DCCF 746 rather than directly to the NF Data Source 748.

ADRF 742 stores historical data and/or analytics, i.e. data and/or analytics related to past time period that has been obtained by the consumer. After the consumer obtains data and/or analytics, consumer may store historical data and/or analytics in an ADRF. Whether the consumer directly contacts the ADRF 742 or goes via the DCDF or via the Messaging Framework is based on configuration.

Data Collection AF (DCAF, not shown in FIG. 7) facilitates data collection from the UE directly or indirectly via the AF, considering both trusted and untrusted AFs.

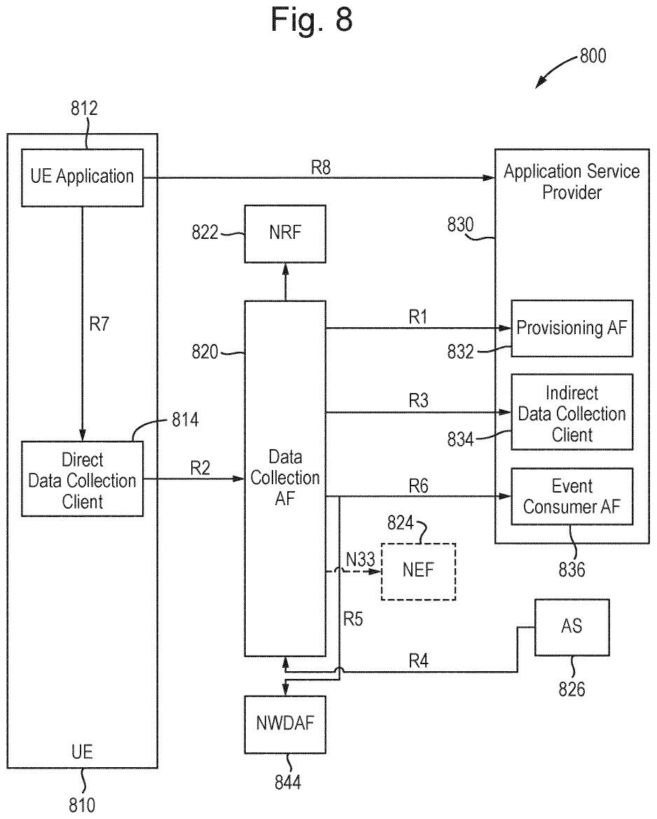

FIG. 8 illustrates a high-level architecture 800 including DCAF 820. The architecture 800 comprises a UE 810, a DCAF 820, a Network Repository Function (NRF) 822, a Network Exposure Function (NEF) 824, an Application Service (AS) 826, an Application Service Provider (ASP) 830, and an NWDAF 844. The UE 810 may comprise a remote unit 102, a user equipment apparatus 200, or a UE 1005, 1410. The UE 810 comprises a UE application 812 and a Direct Data Collection Client (DDCC) 814. The ASP 830 comprises a provisioning application function 832, an indirect data collection client 834 and an event consumer application function 836. The ASP 830 has a Service Level Agreement (SLA) with the network operator related to what data can be collected from the UE 810 by DCAF 820, how it is to be processed and how it is to be exposed. Data Collection AF 820 is responsible for exposing processed UE data to event notification subscribers both inside the trusted domain (such as the NWDAF 844) and outside it (such as the Event Consumer AF 836 in the Application Service Provider 830). Data Collection AF 820 is responsible for ensuring that access to UE data is controlled according to the rules indicated in its provisioning state.

3GPP TS 28.533 v17.2.0 describes a management data analytics service (MDAS) that provides data analytics of different network related parameters including for example load level and/or resource utilization. For example, the MDAS for a network function (NF) can collect the NF's load related performance data, e.g., resource usage status of the NF. The analysis of the received data is per area, slice or slice subnet, and may provide forecast of resource usage information in a predefined future time. This analysis may also recommend appropriate actions e.g. scaling of resources, admission control, load balancing of traffic, etc.

In ORAN RIC, an AI/ML support service is introduced in RIC architecture. This includes Data Pipeline and AI/ML Training. The AI/ML data pipeline in Near-RT RIC offers data ingestion and preparation for applications (xApps). The input to the AI/ML data pipeline may include E2 node data collected over E2 interface, enrichment information over A1 interface, information from applications, and data retrieved from the Near-RT RIC database through the messaging infrastructure. The output of the AI/ML data pipeline may be provided to the AI/ML training capability in Near-RT RIC. The AI/ML training in Near-RT RIC offers training of applications (xApps) within Near-RT RIC. The AI/ML training provides generic and use case-independent capabilities to AI/ML-based applications that may be useful to multiple use cases.

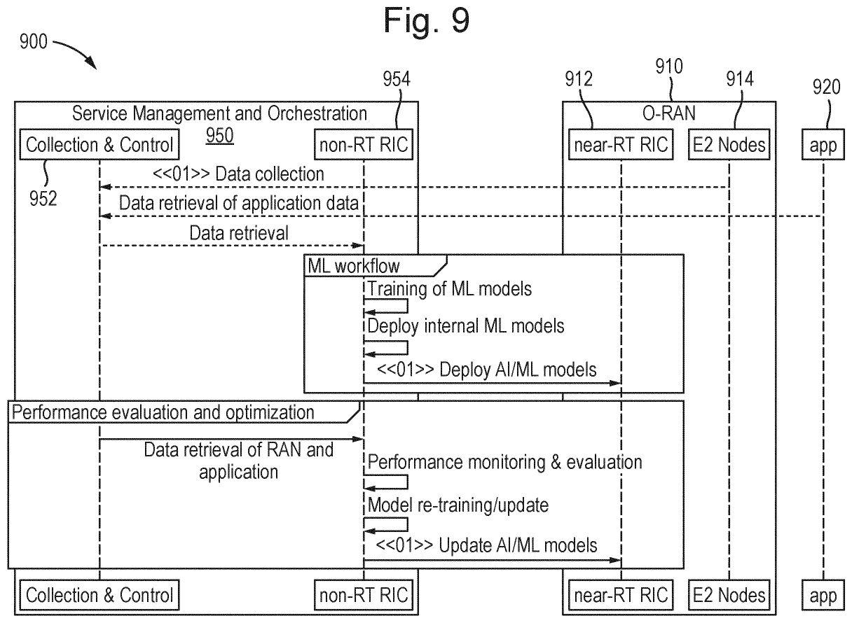

FIG. 9 illustrates an example of an ORAN RIC architecture 900. The architecture 900 comprises an O-RAN 910, an application 920, and a Service Management and Orchestration (SMO) 950. The O-RAN 910 comprises a near-real-time RIC 912 and a plurality of E2 Nodes 914. The SMO 950 comprises a collection & control 952 and a non-real-time RIC 954.

ORAN RIC may also include databases such as UE-NIB and R-NIB. Some xApps may generate UE related information to be stored in the UE-NIB database. UE-NIB maintains a list of UEs and associated data. UE-NIB maintains tracking and correlation of the UE identities associated with the connected E2 Nodes. Some xApps may generate radio access network related information to be stored in the R-NIB database. The R-NIB stores the configurations and near real-time information relating to connected E2 Nodes and the mappings between them.

ORAN RIC also defines a Service Management and Orchestration (SMO). For QoE optimization, the ML training and inference aspects can be distributed between non-RT and near-RT RIC. The application and RAN data are collected from a Collection & Control functionality at SMO (similar to OAM MnS related to PM data), and the ML model training happens at non-RT RIC. The near-RT RIC deploys the models and provides the ML model inference (not shown in the figure). Such models can be used for QoE optimization, and the RAN analytics from E2 nodes is investigated.

RAN analytics information (RAI) as a RAN service can be exposed to RAI service consumers for specific UE. Such a service is defined in O-RAN. WG1.O-RAN-Architecture-Description-v06.00, “O-RAN Architecture Description” section 4.5. Alternatively, the RAN service can be exposed for groups of UE (per slice, per cell, per PLMN, etc.). RAI is envisioned to be helpful for the applications to improve the user experience. Near-RT RIC and E2 interface are leveraged to support this use case. Measurement data through E2 interface, e.g., cell level data, UE level data, can be acquired and processed via ML algorithms to support traffic recognition, QoE prediction, and QoS enforcement decisions. When requested, the analytics information, e.g., traffic rate, latency, packet loss rate, is exposed to the RAI service consumers to help applications execute logical control. In some cases, if QoE related AI/ML models are used from SMO, the Near-RT RIC infers the RAN analytics information, and exposes it to RAI service consumer.

The arrangement described herein targets the enhancement of RAI exposure and data collection, by introducing a new application/RIC function to coordinate the collection of data related to RAN/UE/slice and expose data/analytics to the requestor consumer (RAN analytics function or third party analytics consumer).

In overview, there is provided herein a mechanism for data collection and distribution (DCD) for an external application to allow delivery for RAN analytics.

In some examples, the solution described herein introduces a new xApp, i.e. a DCD xApp for facilitating data collection and distribution and can be seen in certain embodiments as a policy xApp for RAN analytics exposure and data collection. In further embodiments, the solution introduces an AF for facilitating data collection and exposure in integrated O-RAN/5GS scenarios.

This solution introduces: i) for the case of AF an SLA that defines data that can be collected, the abstraction needed (incl. aggregation), and subsequent exposure; and ii) for the case of an xAPP a policy that would govern access to data for purpose of collecting (this data shall be abstracted hiding network and UE insights), the allowed type/purpose of processing and the re-distribution policy towards other business entities.

A benefit that tends to be provided by this solution is to avoid reproducing the same data needed for multiple sources and allowing the collection of data samples to be used for RAN analytics, considering heterogeneous data sources and data of different types and granularities. Data types can be for example real time, near-real time data, offline data, raw data, application and RAN or UE data. Such data processing at the AF/xApp allows the consumer (RAN analytics function or RAN analytics consumer) to receive data/analytics with the required abstraction/format/reporting frequency based on the consumer type and the use case (use case corresponding to the optimization task and the vertical/ASP needs).

A DCD xApp is responsible for coordinating the collection of data via APIs from one or more data sources. Such data collection can be tailored based on the use case (ORAN use cases, e.g., QoE optimization, Localization, traffic steering, . . . ) and/or business agreement with a third party.

An example apparatus comprises: a receiver configured to: receive configuration for data collection based on the use case from SMO/SLA related; receive network authorization and consent for collecting data based on SLA; receive data and/or analytics from one or more data sources (from E2 nodes, RIC database, SMO, other xApps). The apparatus further comprises a processor configured to: discover data sources which are available and can provide the required data; select the data sources and trigger the subscription to the data sources (incl. optionally filtering conditions); combine data targeting the same resources (RAN, UE) from multiple data sources; configured to abstract RAN data and/or analytics-hiding network and/or user insights (e.g., network topology information, user identity, etc.); configure the exposure of data and/or analytics; regulate the sending conditions, e.g., based on network environment or other filters; and select and manage the data receivers. The apparatus further comprises a memory configured to: store data collection configuration per use case; store the data source list (using data source ID) per use case; and store the data processed for distributing to further entities. The apparatus further comprises a transmitter configured to send the processed data and/or analytics to a consumer (RAN data analytics function, other app, etc.).

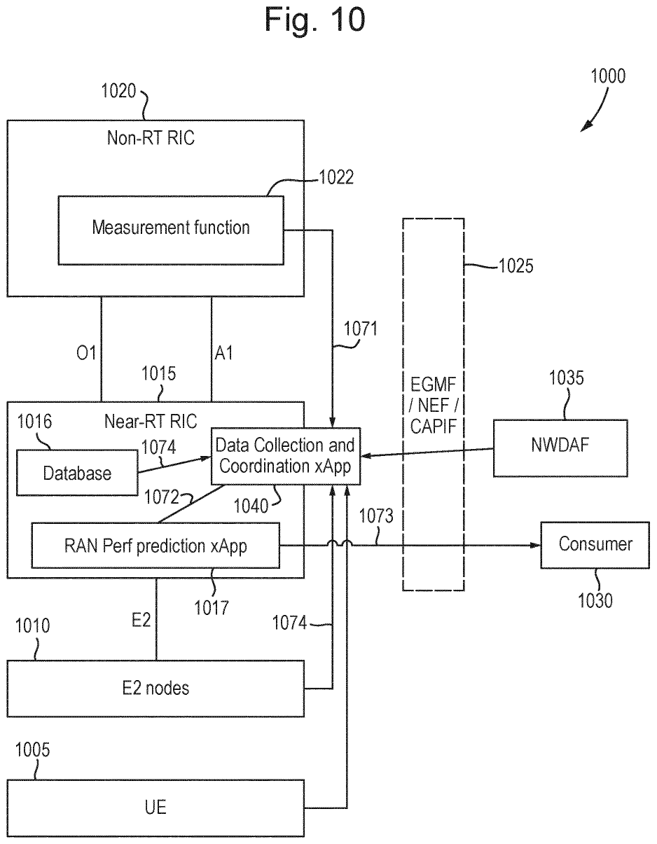

FIG. 10 illustrates a method 1000 performed by the DCD xApp when operating in a system such as a wireless communication network. FIG. 10 shows a UE 1005, a E2 node 1010 such as RAN, a Near-real-time RIC 1015, a non-real-time RIC 1020, a Common API Framework (CAPIF) 1025, a consumer 1030, an NWDAF 1035, and a Data Collection and Coordination Application 1040. The UE 1005 may comprise a remote unit 102, a user equipment apparatus 200, or a UE 810, 1410. Near-real-time RIC 1015 may be a platform and contains a database 1016 and a RAN Perf prediction xApp 1017. The non-real-time RIC 1020 may be comprised within an SMO or an OAM, and includes a measurement function 1022. The measurement function 1022 may be RAN Performance prediction measurement function, a measurements/monitoring rApp or a performance monitoring MnS. CAPIF 1025 is an exposure gateway and may be replaced with an Exposure Governance Management Function (EGMF) or a Network Exposure Function (NEF). CAPIF, EGMF and NEF are different types of exposure gateways. CAPIF can provide unified exposure of RIC APIs. As an alternative the EGMF (gateway defined in OAM) is another option for exposure, and NEF is an exposure function in the 5G core. The NEF may comprise CAPIF in certain implementations. The NWDAF 1035, a MEC RNIS, or another Application Function (AF) may serve as different inputs for the DCD xApp 1040.

3GPP SA 6 has specified a Common API Framework (CAPIF) in 3GPP TS 23.222 v17.6.0. This was developed to enable a unified Northbound API framework across 3GPP network functions, and to ensure that there is a single and harmonized approach for API development. Some key functionalities in CAPIF are: a) CAPIF Core Function (CCF) is a repository of all, PLMN and third party, service APIs; b) API Exposing Function (AEF) is the provider of the services as APIs; and c) API Invoker is typically the applications that require service from the service providers.

The database 1016 may be an SDL, an R-NIB or a UE-NIB. The RAN NIB (R-NIB) database stores information on the E2 nodes, and the UE-NIB contains entries for the UEs and their identity. The UE identity (i.e., the UE-ID) is a key and sensitive piece of information in the RIC, as it allows UE-specific control, but at the same time it can expose sensitive information on the users. The UE-NIB makes it possible to track and correlate the identity of the same user in different E2 nodes. The database can be queried by the different components of the RIC platform (including the xApps) through the Shared Data Layer (SDL) APIs. SDL is a layer comprising database(s) and sometimes is referred as database.

In operation, the DCD xApp 1040 receives 1071 a configuration for data collection based on the use case from the non-real-time RIC 1020 related to the use cases. The configuration may be based on the O-RAN use cases, e.g. it may be vertical specific.

At 1072, the DCD xApp 1040 discovers data sources which are available and can provide the required data.

At 1073, the DCD xApp 1040 selects the data sources and trigger the subscription to the data sources.

At 1074, the DCD xApp 1040 receives data from one or more data sources (from E2 nodes 1010, database, SMO, other xApps). This data may comprise any of:
ML training/inference data from ML support RIC
RAN parameters from R-NIB
UE parameters from UE-NIB
E2 measurements from E2 nodes (UE associated or RAN associated or slice associated)
NWDAF/MDAS data from MNO
other xApp data from SON outputs
MEC RNIS or VIS data
SMO non-RT data

Then, the DCD xApp 1040 combines data targeting the same resources (RAN, UE) from multiple data sources. The received data may comprise any of:
near-RT data related to RAN performance;
near-RT data related to UE performance;
resource availability data; and
QoS/QoE data.

Then, the DCD xApp 1040 abstracts RAN data and/or analytics.

Then, the DCD xApp 1040 stores the data source list (using data source ID) per use case.

Then, the DCD xApp 1040 sends the processed data to a RAN data analytics function.

The CAPIF 1025 regulates the sending conditions, and selects and manage the data receivers.

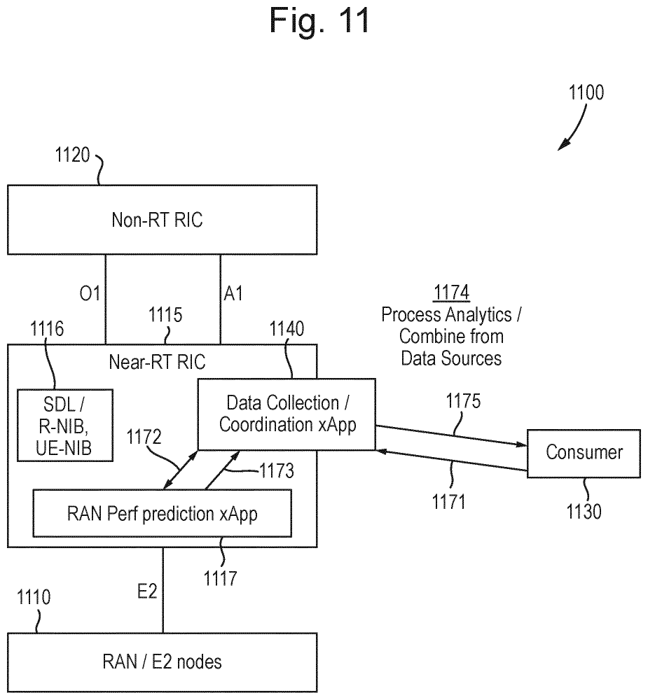

FIG. 11 illustrates a further method 1100 performed by the DCD x App operating in a system such as a wireless communication network. FIG. 11 shows an E2 node 1110 such as RAN, a Near-real-time RIC 1115, a non-real-time RIC 1120, a consumer 1130, and a Data Collection and Coordination Application 1140. Near-real-time RIC 1115 may be a platform and contains a database 1116 and a RAN Performance prediction xApp 1117. The database 1116 may be an SDL, an R-NIB or a UE-NIB. The non-real-time RIC 1120 may comprise a SMO or an OAM.

DCD xApp 1140 is configured to:
receive 1171 data analytics subscription from a RAN analytics consumer 1130;
subscribe 1172 for RAN analytics to RIC or RAN performance prediction xApp 1117;
receive 1173 RAN analytics from one or more data sources based on the analytics event (optionallythe DCD xApp 1140 may combine with data from one or more data sources);
abstract 1174 RAN analytics based on the analytics event; and p1 regulate 1175 the conditions and send RAN analytics to RAN analytics consumer 1130.

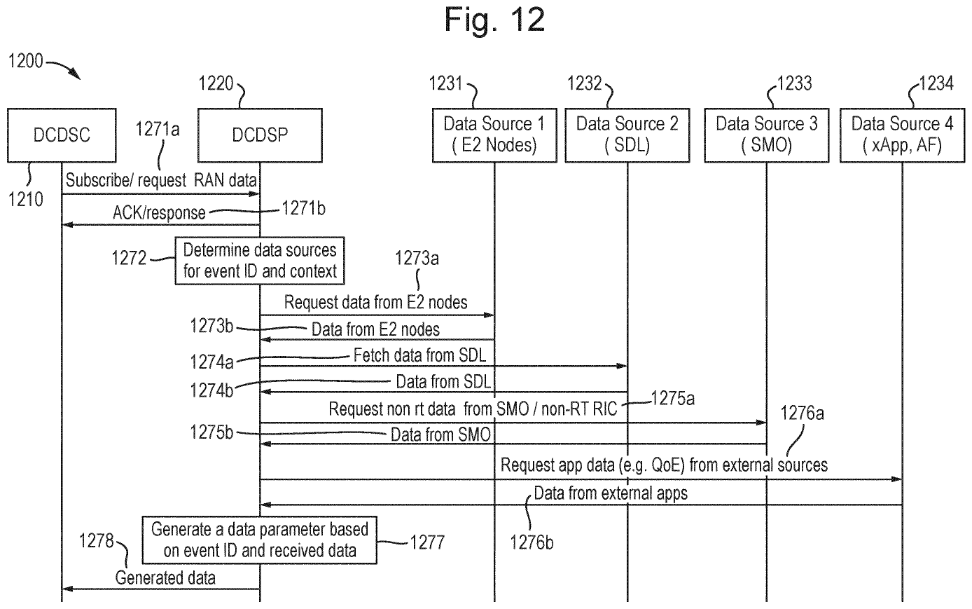

FIG. 12 illustrates an example of a method 1200 of collecting heterogeneous data for deriving RAN Performance Analytics. In this example, the DCD xApp supports the data collection from multiple and heterogeneous sources to allow RAN analytics derivation. So, the consumer can be the RAN analytics function or xApp, and DCD service provider (DCDSP) can allow for combining and processing the data corresponding to the same resources which will be analyzed.

Examples of inputs for a Quality of Experience (QoE) and/or a Quality of Service (QoS) optimization use case:
training or inference QoS/channel performance data from E2 nodes (L2 measurements) which are cell associated or slice associated, or UE associated
RAN parameters from R-NIB including RAN configurations per slice, RRC timers, L2/L3 historical data
UE parameters from UE-NIB
MEC RNIS to provide radio bearer status, RAN UE throughput measurements.
NWDAF to provide QoS sustainability analytics, UE related analytics.
MDAS to provide PM and KPI analytics or NF/slice load, slice throughput for a given cell area or slice
xApps: to provide optimization outputs from xApps (historical data on QoS optimization indications, success/failure ratio in a given area).

Processing at DCD xApp take as input QoS data per cell/slice, QoS analytics from NWDAF/MDAS and QoS near-RT data from E2 nodes/MECapp, and generating expected QoE for a given UE at a given time instance and cell area. This may comprise generation of data samples to be used for QoE model inference.

Possible Outputs are: RAN traffic throughput, average latency, average packet loss rate, QoE parameters.

FIG. 12 illustrates a Data Collection and Distribution Service Consumer (DCDSC) 1210, a Data Collection and Distribution Service Provider (DCDSP) 1220, and a plurality of data sources 1231, 1232, 1234, 1233. DCDSC 1210 may comprise an analytics function or a third party application. DCDSP 1220 may comprise an xApp or a RIC function. A first data source 1231 may comprise an E2 node. A second data source 1232 may comprise an SDL and/or an AI/ML support RIC function. A third data source 1233 may comprise an SMO. A fourth data source 1234 may comprise an xApp, application function or an Mobile Edge Computing Application (MECApp).

A goal of the process 1200 is to Collect Data to derive O-RAN performance analytics information based on external application request (e.g. xApp, MEC, AF). The process may involve Near-RT RIC, application server/MEC/AF, xApp, DCD xApp, SMO, E2 Nodes. A pre-condition of the process is that QoE related models have been deployed in Near-RT RIC respectively. The process begins at 1271a when the consumer 1210 of the Data collection and distribution service (e.g., RAN analytics xApp) requests to receive data related to RAN performance analytics. The request 1271a may be a subscription.

At 1271a, the DCD service consumer 1210 sends a request for analytics (e.g., QoS, QoE data) related to RAN performance analytics event from the DCD service producer (xApp or Near-RT RIC). The request 1271a for analytics may be one-time or subscription-based (periodic or event triggered). The request may include an event ID: “x”, area, time, consumer type/ID, permissions. At 1271b, the DCDSP 1220 sends an Acknowledgement response to DCDSC 1210.

At 1272, the DCD service producer 1220 determines the data sources to request data based on the consumer's request (e.g., based on the analytics event or data collection event).

At 1273, the DCD service producer 1220 collects measurement data from the first data source 1231, in this case E2 Nodes, via a RIC Subscription procedure. The collection may comprise a request 1273a and a response 1273b contain the requested data.

At 1274, the DCD service producer 1220 may collect historical near-real time data from the second data source 1232, in this case UE-NIB and/or R-NIB via SDL APIs. Such data area radio parameters related to a target UE or cell area or slice. The collection may comprise a request 1274a and a response 1274b contain the requested data.

At 1275, the DCD service producer 1220 may collect also non-real time data from a third data source 1233, in this case an SMO based on the RAN analytics exposure event. Such data can be ML training data or application/RAN non-real time data (related to load, energy, performance) from a Data Collection and Control module. The collection may comprise a request 1275a and a response 1275b contain the requested data.

At 1276, the DCD service producer 1220 may also collect data from a fourth data source 1234, in this case external applications (e.g., 5GS AF, SEAL, MEC Apps) related to the per cell or per UE radio measurements. The collection may comprise a request 1276a and a response 1276b contain the requested data.

At 1277, a Near-RT RIC in the DCDSP 1220 processes the data received from one or more data sources by performing the following:
combines data corresponding to different granularities;
filters data and uses the most recent/better “quality”; or
manipulates or abstracts data of a different type to the needed data based on the request.

At 1278, the DCD service producer 1220 sends the processed data to the DCD service consumer 1210. The process ends when the DCD service Consumer 1210 receives the data used to derive RAN analytics.

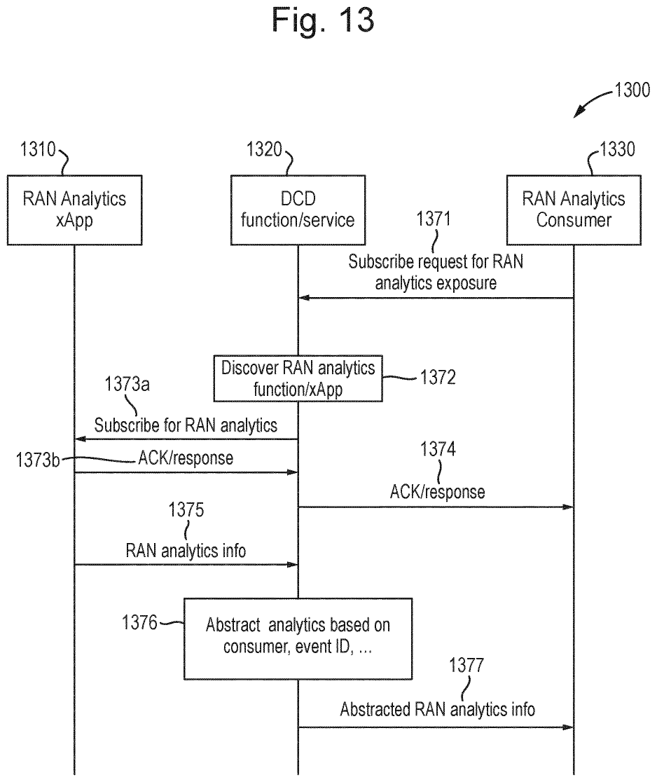

FIG. 13 illustrates a process 1300 for exposing RAN analytics using a DCD xApp. The DCD xApp supports the exposure of RAN analytics information and the abstraction/processing to customize according to the business agreements the exposure per analytics consumer or event, and at the same time to provide a secure and a standardized way of analytics exposure (e.g., by hiding the topology) via a specific RIC API. Such role of DCD xApp can be seen as an intermediate layer which can also get further data from O-RAN sources to allow more accurate analytics.

FIG. 13 shows a RAN Analytics xApp 1310, a DCD function 1320, and a RAN Analytics Consumer 1330. The RAN Analytics xApp 1310 may comprise a RIC. The DCD function 1320 may be a DCD service, and may comprise an xApp or a RIC function. The RAN Analytics Consumer 1330 may comprise a RAI Requester.

The process 1300 provides RAN analytics exposure with the required abstraction and accuracy. The process 1300 is performed by the DCD function 1320, which may be a service producer xApp or RIC function. The DCD xApp is authorized to support RAN Analytics exposure.

The process 1300 begins when the RAN analytics consumer 1330 of the Data collection and distribution service (e.g., 3rd party app) determines a need to request/subscribe to receive RAN performance analytics.

At 1371, the RAN Analytics Consumer 1330 sends a requests for RAN analytics information from DCD xApp running in the DCD function 1320. The request 1371 for RAN analytics information may be one-time or subscription-based (periodic or event triggered). The request 1371 may include an event ID: “x”, an analytics ID, an xApp ID and/or type, area, time, consumer type/ID, and/or permissions.

At 1372, the DCD xApp running in the DCD function 1320 discovers the RAN analytics function or RIC internal RAN performance analytics xApp. Such discovery may be with the support of CAPIF CCF (if used) or via API enablement module in RIC platform (via requesting API information on the RAN analytics xApps hosted at the platform).

At 1373 DCD xApp running in the DCD function 1320 subscribes to RAN analytics function 1310, using the ID/credentials of the end consumer (app server, MEC, etc.) as well as the analytics event/ID and needed confidence level, etc. The subscription may comprise a request 1373a and an acknowledgement 1373b received in reply.

At 1374, upon receiving a response from RAN analytics function 1310, the DCD xApp 1320 sends an ACK/response to end consumer 1330.

At 1375, the Near-RT RIC 1310 generates the RAN analytics information, using QoE related AI/ML models and collected measurement data. ; and sends this information to DCD xApp 1320.

At 1376, the DCD xApp running in the DCD function 1320 abstracts this information or formulates based on the consumer needs (e.g. filtering, tailors reporting, reporting timing and frequency based on the consumer profile, or translates to an abstracted event, e.g. predicted QoS downgrade indication, or anonymizes the data or hides RAN topology etc). Optionally, the DCD xApp running in the DCD function 1320 may obtain supplementary data from data sources in O-RAN.

At 1377, the DCD xApp sends abstracted/processed RAN analytics information to the consumer 1330 (application server, MEC or NF or other xApp etc). The process ends when the Consumer 1330 receives the RAN analytics information.

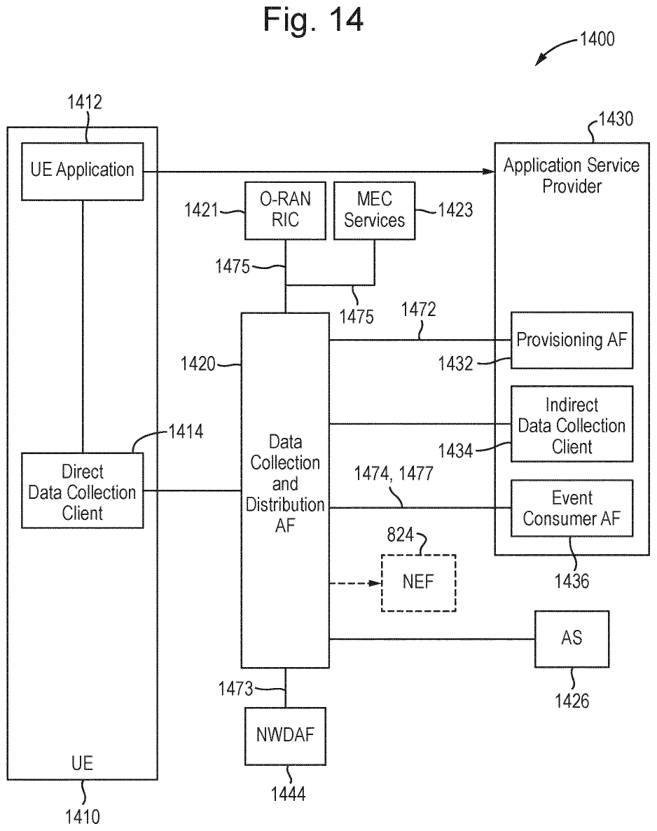

FIG. 14 illustrates an architecture 1400, wherein a DCD AF as enhancement of DCAF. Here, the DCD function is not at O-RAN side, but it is deployed as trusted AF at 3GPP system. In such embodiment, the DCD AF is an enhancement of DCAF and collects data not only from UE and App server (as in DCAF) but also from O-RAN/MEC entities and processes heterogeneous data related RAN. The architecture 1400 comprises a UE 1410, a DCDAF 1420, a Network Repository Function (NRF) 1422, an ORAN RIC 1421, an MEC service 1423, an Application Service (AS) 1426, an Application Service Provider (ASP) 1430, and an NWDAF 1444. The UE 1410 may comprise a remote unit 102, a user equipment apparatus 200, or a UE 810, 1005. The UE 1410 comprises a UE application 1412 and a Direct Data Collection Client (DDCC) 1414. The ASP 1430 comprises a provisioning application function 1432, an indirect data collection client 1434 and an event consumer application function 1436.

The Data Collection and Distribution AF 1420 registers itself with the ORAN RIC 1421, an MEC service 1423. This registration includes a list of Event IDs that it is capable of exposing to event consumers. Also, the registration includes the capabilities related to receiving RAN/O-RAN related data and application data from RIC and/or MEC services/apps (RNIS).

At 1472, the Provisioning AF 1432 discovers the Data Collection and Distribution AF 1420 by following the Nnrf_NF Discovery procedure defined in clause 5.2.7.3 of 3GPP TS 23.502v17.5.0 . The Provisioning AF 1432 provisions data collection and reporting in the Data Collection and Distribution AF 1420 for a specific Event ID, using the Ndcaf_DataReportingProvisioning procedures defined herein. The provisioning information may vary depending on the data reporting method, and the type of data (UE or RAN related).

At 1473, the NWDAF 1444 discovers the Data Collection and Distribution AF 1420 by following the Nnrf_NFDiscovery procedure defined in clause 5.2.7.3 of 3GPP TS 23.502 v17.5.0 and then subscribes to event(s) of interest by invoking the Naf_EventExposure_Subscribe service operation defined in clause 5.2.19.2.2 of 3GPP TS 23.502 v17.5.0 on the discovered Data Collection AF.

At 1474, the Event Consumer AF 1436 discovers Data Collection and Distribution AF 1420 and then subscribes to event(s) of interest by invoking the Naf_EventExposure_Subscribe service operation on the discovered Data Collection AF. Such events may also include the UE related events or the RAN related events from an area covered by O-RAN network.

At 1475, the Data Collection and Distribution AF discovers the RIC 1421 and/or MEC services 1423 to be used as data sources from the RAN/O-RAN related data and/or analytics.

The Data Collection and Distribution AF 1420 acquires the data from RIC/MEC services 1421, 1423 and processes the data (possibly combining with UE data from UEs or Application Servers).

At 1477, the Data Collection and Distribution AF sends the data including the O-RAN/RAN data and/or analytics to the event consumer AF 1436 and/or NWDAF based on the event ID/type.

Accordingly, there is provided herein a new xApp related to data collection and distribution for RAN analytics exposure. The benefit having such an entity is that an external entity or a vendor or a vertical customer can coordinate the data collection from multiple sources and can allow for unified/secure analytics exposure to the third party customer. Such entity can be activated or deployed on demand in certain areas or time for events etc. where the data may not be sufficient or more data is needed to allow for more accurate analytics.

There is further provided a method for heterogeneous radio related data and/or analytics collection and exposure for virtualized radio access networks, the method comprising: discovering at least one data source corresponding to the RAN analytics event, determining at least one data source corresponding to a RAN analytics event, the analytics event comprising an SLA; obtaining data from at least one data source; processing the obtained data; storing the data source list (using data source ID) per use case; sending the processed data to a RAN data analytics function; regulating the sending conditions.

The processing may comprise one or more of: combine data targeting the same resources (RAN, UE) from multiple data sources (near-RT data related to RAN performance, near-RT data related to UE performance, resource availability data, QoS/QoE data, location/positioning data); and abstracting RAN data and/or analytics.

The data may comprise ML training/inference data from ML support RIC, RAN parameters from R-NIB, UE parameters from UE-NIB, E2 measurements from E2 nodes (UE associated or RAN associated or slice associated), NWDAF/MDAS data from MNO, other xApp data from SON outputs, MEC RNIS or VIS data, SMO non-RT data.

The method may further comprise receiving data analytics subscription from a RAN analytics consumer. The method may further comprise subscribing for RAN analytics to RIC or RAN performance xApp. The method may further comprise receiving RAN analytics from one or more data analytics sources based on the analytics event. The method may further comprise combining data from one or more data sources. The method may further comprise abstracting RAN analytics based on the analytics event. The method may further comprise regulating the conditions and sending of RAN analytics to RAN analytics consumer(s).

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are used in the filed addressed herein: 3GPP, 3rd Generation Partnership Project; RRC, Radio Resource Control; RRM, Radio Resource Management; RIC, RAN Intelligent Controller; CU, Central Unit; DU, Distributed Unit; ICIC, Intercell Interference Coordination; FFR, Fractional Frequency Reuse; SEAL, Service Enabler Architecture Layer; LMF, Location Management Function, ; SMO, Service Management and Orchestration; SON, Self Organized Networks ; SLA, Service Level Agreement; DCCF, Data Collection Coordination Function; ADRF, Analytics Data Repository Function; DCAF, Data Collection Application Function; RAI, RAN analytics information; DCD, Data Collection and Distribution; DCDSP, DCD Service Provider; DCDSC, DCD Service Consumer; VIS, V2X information service; R-NIB, RAN—Network Information Base; UE-NIB, user equipment—Network Information base; SDL, shared data layer; RT, Real time; AF, Application function; NEF, network exposure function; QoE, Quality of Experience; MEC, Mobile Edge Computing; CCF, CAPIF Core Function; EGMF, Exposure Governance Management Function; RNIS, Radio Network Information Service; and ADAES, Application Data Analytics Enablement Service.

What is claimed is:

1. A method in a data collection and distribution application entity, the method comprising:
receiving a request from a service consumer, wherein the request is related to a radio related performance analytics event;
determining at least one data source for data collection related to the radio related performance analytics event;
configuring, based at least in part on the radio related performance analytics event, at least one parameter related to data collection from at least one determined data source;
sending the at least one configured parameter to the at least one data source based at least in part on the radio related performance analytics event;
receiving data from the at least one data source;
processing the received data to produce processed data; and
sending the processed data to the service consumer.

2. The method of claim 1, wherein the data collection and distribution application entity comprises an xApp.

3. The method of claim 1, wherein the request from the service consumer comprises one or more of a data subscription request or an analytics event subscription request.

4. The method of claim 1, wherein the radio related performance analytics event relates to a service level agreement between the service consumer and the data collection and distribution application entity.

5. (canceled)

6. The method of claim 1, wherein processing the received data comprises abstraction.

7. The method of claim 1, wherein processing the received data comprises combining data collected from a plurality of data sources.

8. The method of claim 1, further comprising storing a data source list with the request for analytics related to a radio related performance analytics event.

9. The method of claim, claim 1, further comprising sending analytics to the service consumer when a sending 22 condition is satisfied.

10. The method of claim 1, further comprising registering the data collection and distribution application entity with each of a plurality of data sources.

11. The method of claim 10, wherein determining the at least one data source for data collection related to the radio related performance analytics event comprises selecting data sources from the plurality of data sources with which the data collection and distribution application entity is registered.

12. A data collection and distribution application entity comprising:
at least one memory; and
at least one processor coupled with the at least one memory and configured to cause the data collection and distribution application entity to:
receive a request from a service consumer,
wherein the request is related to a radio related performance analytics event;
determine at least one data source for data related to the radio related performance analytics event;
configure, based at least in part on the radio related performance analytics event, at least one parameter related to data collection from at least one determined data source;
send the at least one configured parameter to the at least one data source based at least in part on the radio related performance analytics event;
receive data from the at least one data source;
process received data to produce processed data; and
send the processed data to the service consumer.

13. The data collection and distribution application entity of claim 12, wherein the data collection and distribution application entity comprises an xApp.

14. The data collection and distribution application entity of claim 12, wherein the request from the service consumer comprises one or more of a data subscription request or an analytics event subscription request.

15. The data collection and distribution application entity of claim 12, wherein the radio related performance analytics event relates to a service level agreement between the service consumer and the data collection and distribution application entity.

16. The data collection and distribution application entity of claim 12, wherein to process the received data comprises abstraction.

17. The data collection and distribution application entity of claim 12, wherein to process the received data comprises combining data collected from a plurality of data sources.

18. The data collection and distribution application entity of claim 12, wherein the at least one processor is further configured to cause the data collection and distribution application entity to store a data source list with the request for analytics related to a radio related performance analytics event.

19. The method of claim 1, wherein the received data comprises at least one of:
one or more of machine learning training data or machine learning inference data;
radio access network parameters from a radio access network-network information base;
user equipment parameters from a user equipment-network information base;
E2 data from one or more E2 nodes;
data analytics from one or more 3GPP sources;
data from one or more xApps associated with one or more of self-organized networks or radio resource management outputs;
radio related data from one or more of a mobile edge computing radio network information service or a V2X information service; or
non-real time data from one or more of service management and orchestration or operations administration and management.

20. A network entity for wireless communication, comprising:
at least one memory; and
at least one processor coupled with the at least one memory and configured to cause the network entity to:
receive a request from a service consumer, wherein the request is related to a radio related performance analytics event;
determine at least one data source for data related to the radio related performance analytics event;
configure, based at least in part on the radio related performance analytics event, at least one parameter related to data collection from at least one determined data source;
send the at least one configured parameter to the at least one data source based at least in part on the radio related performance analytics event;
receive data from the at least one data source;
process received data to produce processed data; and
send the processed data to the service consumer.

21. A processor for wireless communication, comprising:
at least one controller coupled with at least one memory and configured to cause the processor to:
receive a request from a service consumer, wherein the request is related to a radio related performance analytics event;
determine at least one data source for data related to the radio related performance analytics event;
configure, based at least in part on the radio related performance analytics event, at least one parameter related to data collection from at least one determined data source;
send the at least one configured parameter to the at least one data source based at least in part on the radio related performance analytics event;
receive data from the at least one data source;
process received data to produce processed data; and
send the processed data to the service consumer.
